(19) United States
(12) Patent Application Publication
(10) Pub. No.: US 2025/0356035 A1
(43) Pub. Date: Nov. 20, 2025

(54) METHODS FOR APPLYING GENERATIVE AI WITH SECRECY GUARANTEES

(71) Applicant: Fortinet, Inc., Sunnyvale, CA (US)

(72) Inventors: Roy GALILI DARNELL, Rehovot (IL); Tal ZAMIR, Tel Aviv (IL); Haim FELDMAN, Petah Tikva (IL); Ariel PORATH, Tel Aviv (IL); Ofek RONEN, Rosh Haayin (IL); Ohad HARARI, Jerusalem (IL)

(73) Assignee: Fortinet, Inc., Sunnyvale, CA (US)

(21) Appl. No.: 18/669,162

(22) Filed: May 20, 2024

(51) Int. Cl. G06F 21/60; G06F 40/35

(52) U.S. Cl. CPC G06F 21/606; G06F 40/35

(57) ABSTRACT

A method for evaluating data by a generative artificial intelligence (AI) model to determine for an original query containing sensitive data a result and a reason for that result without leaking substantially any of the sensitive data, the method comprising: separating non-sensitive data of the original query and at least one type of the sensitive data; reducing each respective one of the at least one type of sensitive data to one enumerated output selected from a prescribed number of options for that respective type of sensitive data; expanding each enumerated output to a respective expanded form that is usable by the generative AI model; combining the expanded forms with the non-sensitive data to form a prompt; and submitting the prompt to the generative AI model.

### TECHNICAL FIELD

This invention relates to generative artificial intelligence (AI) and, more specifically, to providing secrecy to the underlying data on which query answers are based.

### BACKGROUND

Generative AI, which produces content based on large language models trained on large amounts of data, is enabling a wide variety of new applications. One illustrative application is the ability to determine the status of an email, i.e., whether the email is malicious, spam, or clean, i.e., neither of the foregoing, based on the email's content and its metadata. Furthermore, the generative AI may provide textual reasoning as to why it assigned the particular status to the email. For such an application, the generative AI model is being used for classification purposes, meaning it is being asked a specific question for which it is being provided specific data and the generative AI model is asked to respond in a formatted way. For example, a chat with a generative AI may have a user enter therein: I received the following email which states: “You have got to check this link right now! www.very-malicious.com”. Please help me figure out if this is malicious or not, and only answer yes or no followed by an explanation as to why you so decided. The generative AI could then answer: “Yes, this domain is unknown and suggests it prompts a potential attack. In addition to the urgent notion, this email should be classified as malicious.”

Note that although the example was couched in terms of a user having a chat with the generative AI model, this was for ease of exposition and understanding. It should be recognized that most often such an interaction would actually happen programmatically/automatically and as such no manual work by the user is required. For example, when the system receives an email, it may automatically pass the relevant content to the large language model.

However, there are some issues with employing this technology.

One such issue is data leakage, i.e., the revealing of information that was provided to the generative AI system for use in coming to its determination. This often results when the AI system is providing the reasoning for its decision. When the information provided to the AI system should remain secure, because the information contains private, secret, or sensitive elements, revealing such private, secret, or sensitive elements by the AI system is problematic. Continuing with the email example, a security administrator reviewing the email categorization and the reasoning therefor may not be authorized to view the content of emails when the emails contain sensitive private data, or at least not those parts of the emails.

Another issue with generative AI is that it is desired to operate a generative AI model while not allowing the input to introduce bias into the generative AI's model. For example, a generative AI model that helps classify or evaluate curriculum vitaes (CVs) to determine whether a candidate for a job should be moved to a next phase of a hiring process should ignore or not be influenced by the gender or race of the candidate with whom the CV is associated.

Another issue with generative AI technology is the cost of AI-based content generation. The use of large amounts of input data as part of a query to the AI can lead to higher costs, i.e., in terms of time and resource consumption. Furthermore, such large amounts of input data may potentially “confuse” the model, create hallucinations and lead to reduced accuracy of the result. Also, some of the large amount of data may be unnecessary for content generation.

It would therefore be advantageous to provide an arrangement that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “certain embodiments” may be used herein to refer to a single embodiment or multiple embodiments of the disclosure.

Certain embodiments disclosed herein include a method for evaluating data by a generative artificial intelligence (AI) model to determine for an original query containing sensitive data a result and a reason for that result without leaking substantially any of the sensitive data. The method comprises separating non-sensitive data of the original query and at least one type of the sensitive data; reducing each respective one of the at least one type of sensitive data to one enumerated output selected from a prescribed number of options for that respective type of sensitive data; expanding each enumerated output to a respective expanded form that is usable by the generative AI model; combining the expanded forms with the non-sensitive data to form a prompt; and submitting the prompt to the generative AI model.

Certain embodiments disclosed herein also include non-transitory computer readable medium having stored thereon instructions for causing a processing circuitry to execute a process for evaluating data by a generative artificial intelligence (AI) model to determine for an original query containing sensitive data a result and a reason for that result without leaking substantially any of the sensitive data, the process comprising: separating non-sensitive data of the original query and at least one type of the sensitive data; reducing each respective one of the at least one type of sensitive data to one enumerated output selected from a prescribed number of options for that respective type of sensitive data; expanding each enumerated output to a respective expanded form that is usable by the generative AI model; combining the expanded forms with the non-sensitive data to form a prompt; and submitting the prompt to the generative AI model.

Certain embodiments disclosed herein also include a system for evaluating data by a generative artificial intelligence (AI) model to determine for an original query containing sensitive data a result and a reason for that result without leaking substantially any of the sensitive data. The system comprises a processing circuitry; and a memory, the memory containing instructions that, when executed by the processing circuitry, configure the system to: separate non-sensitive data of the original query and at least one type of the sensitive data; reduce each respective one of the at least one type of sensitive data to one enumerated output selected from a prescribed number of options for that respective type of sensitive data; expand each enumerated output to a respective expanded form that is usable by the generative AI model; combine the expanded forms with the non-sensitive data to form a prompt; and submit the prompt to the generative AI model.

### BRIEF DESCRIPTION OF THE DRAWING

In the drawing:

FIG. 1 shows an illustrative network diagram utilized to describe the various embodiments;

FIG. 2 shows an illustrative flow for implementing the principles of the disclosure;

FIG. 3 shows an illustrative flowchart of a process in accordance with an embodiment; and

FIG. 4 shows an illustrative system 400 that may be employed to implement any of the user device, the system, the LLM, and the database of FIG. 1.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

In accordance with the principles of the disclosure, the sensitive portion of a data set to be evaluated by a generative AI is reduced so as to be represented by a limited number of choices, also known as enumerated values, for the sensitive information that it contains. This effectively scrubs most or all of the sensitive information from the data set and produces a reduced data set. Thereafter, the resulting enumerated values are supplied to a module that deterministically translates each of the enumerated values of the reduced data set into a corresponding textual description that explains to the generative AI what each value means and produces an expanded reduced data set. Each portion of expanded reduced data set derived from the sensitive information is then combined with respective, corresponding non-sensitive data of the original data set that the sensitive information was associated with, e.g., by a prompt construction component, to derive a final prompt that represents both the sensitive and non-sensitive data. The foregoing can be thought of as analogous to applying input data to a filter that reduces the input data to certain choices for the sensitive information and then applying the resulting choices to an inverse filter that takes the choices and expands them into an output, i.e., the expanded reduced data set, that the generative AI can better understand. The resulting final prompts are supplied to the generative AI to develop as output the final desired generated content, e.g., a determination as to the status of an email such as whether the email is malicious, spam, or clean and why such status was determined, or which candidates for a job, if any, should be moved to a next phase of a hiring process and why.

Advantageously, the final output is guaranteed to have no sensitive data except for data of the size of 2 to the power of the number of enum values employed, i.e., where n is an integer representing the number of enum values employed 2\hat{ }n. This is because the generative AI can choose for each enum value whether it exists or not. For example, a generative AI that decides whether an email is “important”, and/or “urgent” and/or “marketing_material” has 3 as the number of enum values and each enum value can take on values of True of False. Thus, in total, there are 8 combinations of the three enum values as 2\hat{ }3=8. More specifically, for the enum values as an ordered set of (<important>, <urgent>, <marketing_material>) the possible combinations are seen to be (False, False, False), (True, False, False), (True, True, False), (True, True, True), (False True, True), (False, False, True), (True, False, True), (False, True, False), making 8.

An additional advantage that is achieved is keeping the generative machine learning model from acting in a biased manner based on the sensitive data as it was not supplied with the sensitive data. A further advantage is that the possibility of causing confusion or hallucination of the generative AI because it is not provided with potentially confusing content in the original sensitive data. Another advantage achieved may be faster speed when the sensitive data is relatively long while the expanded reduced data set is much shorter which may also lead to reduced cost, e.g., monetarily or in terms of resources employed. Thus, not only is secrecy improved but improvements in the computer technology of generative AI is achieved.

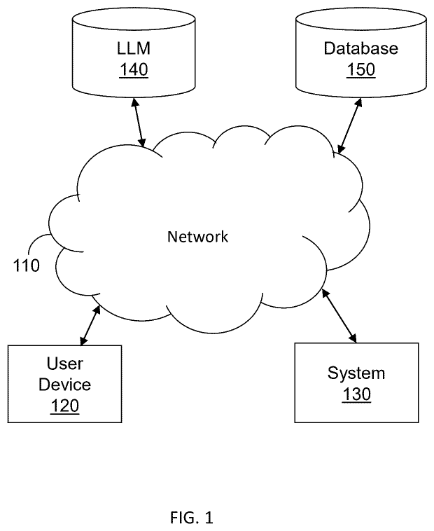

FIG. 1 shows an illustrative network diagram utilized to describe the various embodiments. Shown in FIG. 1 are user device 120, system 130, a large language model (LLM) 140 and database 150 which are all communicatively coupled via network 110.

Network 110 may be, but is not limited to, a wireless, cellular or wired network, a local area network (LAN), a wide area network (WAN), a metro area network (MAN), the Internet, the worldwide web (WWW), similar networks, and any combination thereof.

User device (UD) 120 may be, but is not limited to, a personal computer, a laptop, a tablet computer, a smartphone, a wearable computing device, or any other device capable of transmitting and receiving information is capable of providing information in a human perceivable form.

System 130 controls the preparation of one or more queries, i.e., prompts, to be submitted to LLM 140. System 130 prepares the prompts based on data from a data source that may contain sensitive information that should not be revealed by LLM 140. The data source may be stored in database 150.

LLM 140 may be any generative machine learning model, such as a generative artificial intelligence (AI) model. The generative machine learning model may not only be a model that is text or language based but may also be or include models that operate on images, audio, video, and so forth. Nevertheless, for convenience and brevity herein such generative artificial intelligence models are referred to herein as LLM. LLM 140 may be hosted in a cloud computing platform, such as, but not limited to, a private cloud, a public cloud, a hybrid cloud, or any combination thereof. LLM 140 may be any conventional generative machine learning model.

The database 150 may be any storage device, set of devices, or a data warehouse that is configured to store data.

It should be noted that, although one client 120 and one LLM 140 are illustrated in FIG. 1 this is merely for the sake of clarity of exposition and the embodiments disclosed herein can be applied to a plurality of clients or LLMs.

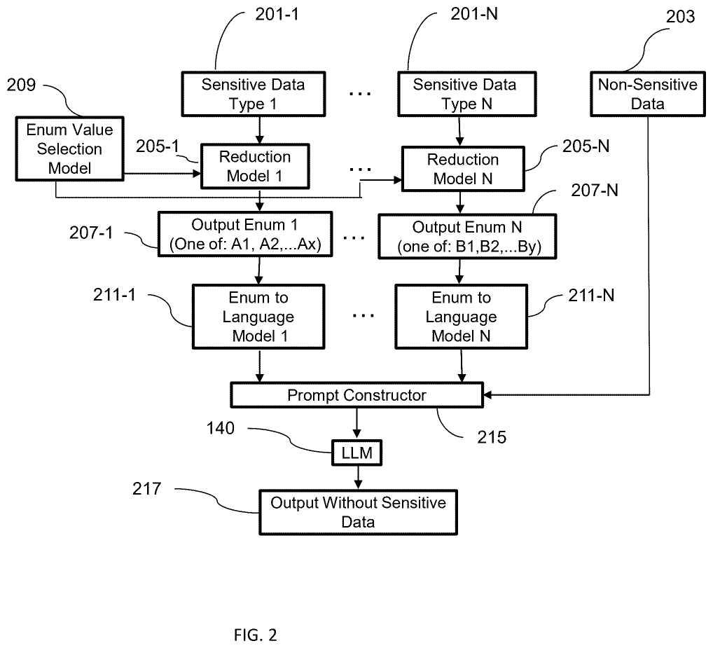

FIG. 2 shows an illustrative flow for implementing the principles of the disclosure. More specifically, data to be processed by a generative machine learning model, e.g., an LLM, is first preprocessed in order to reduce the possibility of sensitive data leaking through to the answer provided by the LLM and to possibly improve the processing speed. The data to be processed may be supplied from user device 120 or database 150. Such data to be processed may be supplied on a per request basis, e.g., individually or in a batch, and may, but need not, involve any human action. For example, emails arriving at user device 120 may automatically be processed as they arrive. Alternatively, a user may request that a batch of resumes, e.g., stored in database 150, be processed.

The data to be processed typically has both sensitive data of various types, e.g., sensitive data type 1 201-1 through sensitive data type N 201-N, where N is an integer greater than 1, as well as various types of non-sensitive data which may be treated altogether as non-sensitive data 203. The totality of the data to be processed is split into the various types of sensitive data and the non-sensitive data for further processing. Note that in certain embodiments there may only be one type of sensitive data, and so there would be no sensitive data type other than sensitive data type 1 201-1.

Each type of sensitive data may be supplied to a respective reduction model. Thus, sensitive data type 1 201-1 may be supplied to reduction model 1 205-1 while sensitive data type N 201-N may be supplied to reduction model N 205-N. Each reduction model takes its input, analyzes it, and provides as an output one of a set of prescribed enumerated outputs that is determined to correspond to the specific input. Such output is referred to as an output enum or just an enum. It may also be referred to as multi-label data. Referring to the example above of the enum values as an ordered set of (<important>, <urgent>, <marketing_material>) the output enum is one of the 8 possible combinations listed above one of which may be, for example, (True, False, True).

In FIG. 2 the output enum produced by reduction model 1 205-1 is output enum 1 207-1. The output enum produced by reduction model N 205-N is output enum 1 207-N. The output enum for each sensitive data type is chosen from a small set of options that are deemed to correspond to or describe the particular sensitive data input. For example, the output enums 207-1 that can be produced by reduction model 205-1 are A1, A2 through Ax. Thus, based on the sensitive data that is supplied to reduction model 1 it will choose for output one of the values A1, A2 through Ax, where x is a small integer. Similarly, the output enums 207-N that can be produced by reduction model 205-N are B1, B2 through By, where y is a small integer. Thus, based on the sensitive data that is supplied to reduction model 1 it will choose to output one of the values A1, A2 through Ax.

As noted, x and y are small integers. Some embodiments use no more than 32 different output enums per reduction model, which is representable by 4 bytes. However, this number may be greater, for example, even using 1024 enums per model there is no more than 0.125 kb of data leakage that could occur. For example, with regard to the subject of an email, the options from which a reduction model may choose, i.e., the potential output enums, may be FORMAL, CASUAL, and URGENT. Note that the options are chosen so as to not contain any sensitive data, even though the subject itself may contain sensitive data, and thus reducing the chance of leaking of sensitive data.

In some embodiments, one or more of the reduction models may be implemented as being particularized to the type of sensitive data that they are expected to reduce. Thus, as an example, various ones of the reduction models may be implemented as individual particularized LLMs trained for the purposes of providing the enumerated outputs that correspond to the various possible sensitive data of the type that is supplied to it. In other embodiments a reduction model may be more generalized and may be able to process and reduce different types of sensitive data. Furthermore, a combination of particularized and more generalized reduction models may be employed as appropriate to the data types and available models, as will be recognized by those of ordinary skill in the art. Thus, it should be appreciated that FIG. 2 is a logical representation and not necessarily a physical representation.

Enum value selection model 209 may supply to reduction models 205 the choices available to be produced by the reduction, i.e., the particular values that may be supplied as output by each of reduction models 205, e.g., A1, A2, . . . . Ax. Note, however, that enum value selection model 209 is an optional model that typically operates during a training phase of the system and does not need to be employed when the system is processing live, i.e., not training, data. To this end, the specific output enum values to be employed may be supplied as outputs of enum value selection model and stored in the various reduction models 205.

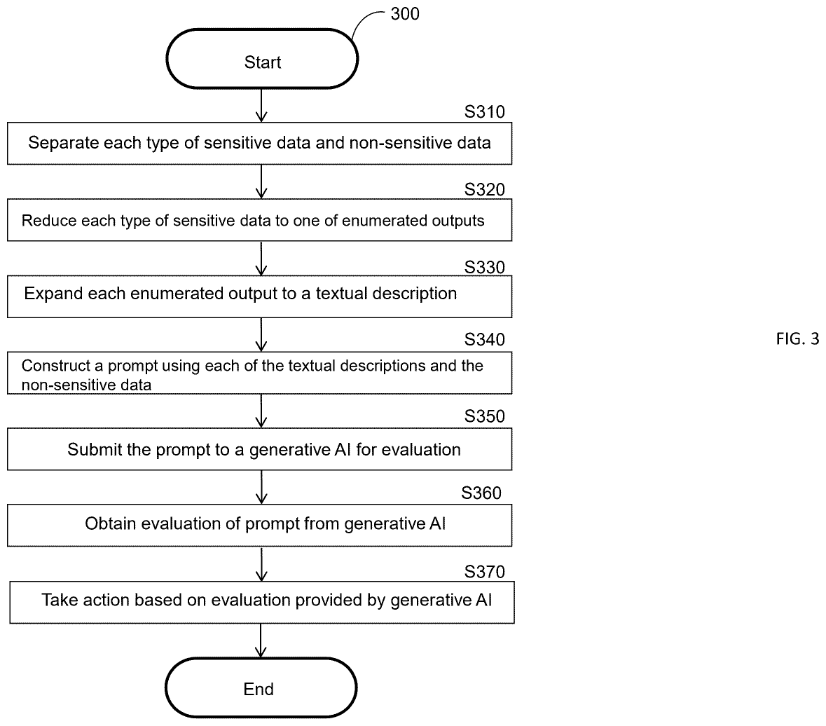

The output enum values employed, i.e., supplied as output by enum value selection model 209, can be determined in a number of ways. One such way is by manually supplying a set of output enum values to enum value selection model 209. Another possible way is to employ an enum value selection model 209 which tries out various possible output enum values until it gets good results when the flow represented by FIG. 2 or the process of FIG. 3 is run on training data for which there are known results that are expected to be supplied as output by LLM 140. For example, a variety of output enum values could be selected by enum value selection model 209 and then tested by running the whole process using those enum values and seeing if the results are good, i.e., if a prescribed percentage of results obtained match the known results. If the results are good, nothing further need be done and the output enum values employed in the previous iteration using the training data are employed. If the results are not good, new possible enum values are selected by enum value selection model 209 and the flow represented by FIG. 2 or the process of FIG. 3 is run again on training data. This may be repeated until the results obtained are good.

As example, training data of 1000 training emails are provided for which the answer to the overall question being asked, i.e., the classification of the emails, is known. The emails are processed using a selected set of potential enum values selected by enum value selection model 209 and if a prescribed percentage or more of the training emails are properly classified by LLM 140 using the currently selected potential enum values the currently selected enum values may be considered to be good and then used with non-training data. If the currently selected enum values are not considered to be good, a new set of selected set of potential enum values is selected by enum value selection model 209 and the process of seeking a good set of enum values is repeated.

As a more detailed example, initially, an email's language style can be classified as “formal”, “casual”, “urgent”. The entire flow represented by FIG. 2 or the process of FIG. 3 is run on training data using these possible enum outputs. It may then be discovered that there is an error level of a certain amount, e.g., a prescribed percent of the results produced by the LLM do not match what the training data is known to be. If the error is too high, i.e., greater than a prescribed threshold, it is requested that enum value selection model 209 suggests other enum option values. Such may be based on the specific mistakes that the LLM made during its previous processing of the training data using the previous enum option values. Continuing with the previous example where the possible enum outputs were formal, casual, and urgent, enum value selection model 209 might add an additional value called “obfuscated”, so that now the possible classifications are formal, casual, urgent, and obfuscated. The entire process is run again on the same training data. If the error is now less than or equal to the threshold the process may stop and the enum option values just determined may be employed. Otherwise, it may again be requested that enum value selection model 209 suggests other enum option values and the process is repeated.

Given that an LLM requires a textual query in order to answer a question, such textual query being referred to herein as a prompt, the output enum values must be converted to the type of language that an LLM can employ. To this end, the output from the reduction model is passed on to an enum to language model component, e.g., enum to language model 1 211-1 through enum to language model N 211-N each of which deterministically translates the discrete output enum values to a corresponding textual description of each option to explain to the next model what each value means.

As an example, where the possible enum output values are FORMAL, CASUAL, and URGENT the enum to language model could supply when it encounters the FORMAL output enum: “An email with formal language style”, when it encounters the CASUAL output enum it could supply: “An email with a casual/informal language style”, while when for the URGENT output enum it could supply: “An email which urges the recipient to respond”.

Thus, each of enum to language models 211 expands the output enums into a textual representation suitable to be submitted to an LLM, in a sense reversing the process performed by the reduction models 205, but in a way such that none of the actual sensitive information is contained in the expanded textual representations. The result is an expanded reduced data set for each sensitive data type but which does not include any of the sensitive data.

The textual representations produced by enum to language models 211, non-sensitive data 203, and possibly other relevant non-sensitive knowledge and context are supplied as input to prompt constructor 215. For example, non-sensitive data 203 may be an IP address or a domain age, where domain age refers to how many days ago was a domain registered, e.g. google.com was registered a long time ago, which is publicly available information. Prompt constructor 215 constructs a prompt using the all of the input supplied thereto, where the prompt describes the entirety of the input, i.e., including all of the input parts. The prompt developed by prompt constructor 215 thus represents the original item supplied for evaluation, as well as instructions and relevant general knowledge, but without containing any of the sensitive data.

For example, a prompt may include content from an email along with the expanded textual representation of the output enums and ask if the email is malicious, spam, or clean and why it was so decided. As another example, a prompt could include content from a curriculum vitae (CV) along with the expanded textual representation of the output enums and be asked whether a candidate for a job should be moved to a next phase of a hiring process or not and why it was so decided.

Furthermore, as indicated above, the prompt may possibly be enriched with additional context and know-how, which is not sensitive data. With regard to enrichment, this is the adding of additional relevant information intended to help LLM 140 understand how to respond. For example, consider the email example above of wanting LLM 140 to help with a received email, where the user enters: I received the following email which states: “You have got to check this link right now! www.very-malicious.com”. Please help me figure out if this is malicious or not, and only answer yes or no followed by an explanation as to why you so decided. It may be possible that there is available to LLM 140 information about different domains which may indicate that “www.very-malicious.com” is not actually a malicious website at all. Having such information available may enable LLM 140 to make the right decision with regard to the particular query, and so such relevant available information may be provided to LLM 140 in the prompt.

For example, a reputation engine may have found that www.very-malicious.com has a reputation score of 0.9. However, LLM 140 does not know whether a score of 0.9 indicates a good reputation or a bad reputation and how good or bad such reputation is. Additionally, many conventional generative AI models benefit from being provided with information in the form of natural language as opposed to simply being provided with numeric values. For example, if a reputation score is higher than 0.85 and such is a score is considered an excellent reputation, then the prompt should be modified from what is given above to: I received the following email which states: “You have got to check this link right now! www.very-malicious.com” and fact: the domain www.very-malicious.com has an excellent reputation as clean. Please help me figure out if this is malicious or not, and only answer yes and no followed by an explanation as to why you so decided.”

Each prompt is submitted to a generative machine learning model, e.g., LLM 140. The generative machine learning model determines the answer to the prompt and provides its output 217, e.g., which may be sent to user device 120, but, advantageously, such output substantially does not contain any of the sensitive data, i.e., it can only contain data of the size of 2 to the power of the number of enum values employed, i.e., where n is an integer representing the number of enum values employed 2\hat{ }n. Furthermore, since, advantageously, the generative machine learning model was not supplied with the sensitive data, it cannot be biased by the sensitive data. Likewise it cannot become confused or suffer hallucination should the original sensitive data be confusing. Another advantage achieved may be faster speed when the sensitive data is relatively long while the expanded reduced data set is much shorter thus leading to reduced cost, e.g., monetarily or in terms of resources employed.

It should also be appreciated that further action may be taken based on the answer to the prompt, e.g., by having LLM 140 supply its output to system 130. For example, emails classified as malicious or spam may be automatically discarded or stored by system 130 in a quarantine folder while emails classified as clean may be forwarded by system 130 to user device 120, e.g., to the user's inbox. Alternatively, the emails may all be transmitted to user device 120 which then separates them, e.g., into separate mail bins for spam, malicious, and safe based on the answer provided by the LLM. However, a user could then review the rationale given for any email as to why it was so classified, e.g., those in the particular bins and based on the rationale may then decide to move any email from one bin to another.

Another example of action taken in response to the answer of the prompt relates to CV evaluation. System 130 could receive the evaluations and the reasons therefor and then forward to user device 120 only those indicated by the generative AI that should be moved to a next phase of a hiring process while retaining for possible later review and evaluation the remaining CVs should the user desire to do so. The user device 120 is also supplied with the reasoning as to why the generative AI concluded that the candidate should be advanced to the next phase.

FIG. 3 shows an illustrative flowchart of a process in accordance with an embodiment. The process is entered in step 300 when there is new data to be processed. In S310 each type of sensitive data is separated from each other type of sensitive data and also the non-sensitive data is separated from all of the sensitive data. Next, in S320, each type of sensitive data is reduced to one of a prescribed number of enumerated outputs, thereby nearly completely eliminating any leakage of the sensitive data. Thereafter, in S330, the enumerated output for each of the sensitive data types is converted into a textual description. Following that, in S340, a prompt is constructed using each of the textual descriptions developed in S330 along with the non-sensitive data and, optionally, any available context or know-how information. The prompt is then submitted to a generative AI for evaluation in S350. The output of the generative AI Is obtained in S360 and appropriate action based thereon is taken in S370.

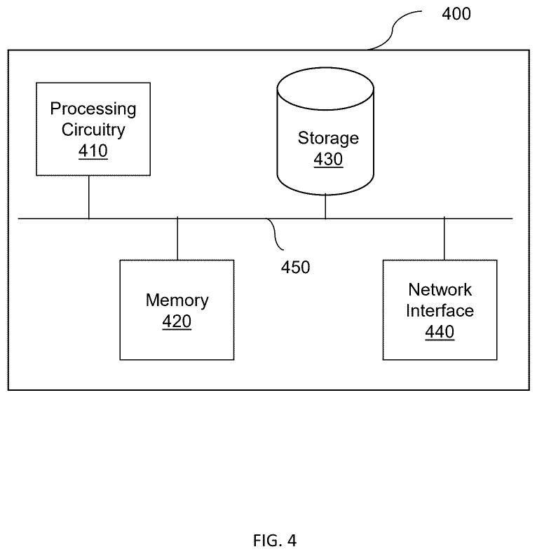

FIG. 4 shows illustrative system 400 which may be employed to implement any of user device 120, system 130, LLM 140, and database 150. System 400 includes processing circuitry 410 coupled to memory 420, storage 430, and network interface 440. In an embodiment, the components of the system 400 may be communicatively connected via a bus 450.

The processing circuitry 410 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), AI accelerators, and the like, or any other hardware logic components that can perform calculations or other manipulations of information.

The memory 420 may be volatile, e.g., random access memory, etc., non-volatile, e.g., read only memory, flash memory, etc., or a combination thereof.

In one configuration, software for implementing one or more embodiments disclosed herein may be stored in the storage 430. In another configuration, the memory 420 is configured to store such software. Software shall be construed broadly to mean any type of instructions, whether referred to as software, firmware, middleware, microcode, hardware description language, or otherwise. Instructions may include code, e.g., in source code format, binary code format, executable code format, or any other suitable format of code. The instructions, when executed by the processing circuitry 410, cause the processing circuitry 410 to perform the various processes described herein.

The storage 430 may be magnetic storage, optical storage, and the like, and may be realized, for example, as flash memory or other memory technology, compact disk-read only memory (CD-ROM), Digital Video Disks (DVDs), or any other medium which can be used to store the desired information.

The network interface 440 allows the system 400 to communicate with components external thereto, e.g., over network 110.

It should be understood that the embodiments described herein are not limited to the specific architecture illustrated in FIG. 4, and other architectures may be equally used without departing from the scope of the disclosed embodiments.

The various embodiments disclosed herein can be implemented as hardware, firmware, firmware executing on hardware, software, software executing on hardware, or any combination thereof. Moreover, the software is implemented tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (CPUs), a memory, and input/output interfaces. The computer platform may also include an operating system and microinstruction code. The various processes and functions described herein may be implemented as either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for evaluating data by a generative artificial intelligence (AI) model to determine for an original query containing sensitive data a result and a reason for that result without leaking substantially any of the sensitive data, the method comprising:
separating non-sensitive data of the original query and at least one type of the sensitive data;
reducing each respective one of the at least one type of sensitive data to one enumerated output selected from a prescribed number of options for that respective type of sensitive data;
expanding each enumerated output to a respective expanded form that is usable by the generative AI model;
combining the expanded forms with the non-sensitive data to form a prompt; and
submitting the prompt to the generative AI model.

2. The method of claim 1, wherein the form usable by the generative AI model is a textual language form.

3. The method of claim 1, further comprising:
receiving an evaluation of the prompt from the generative AI model; and
taking an action based on the received evaluation.

4. The method of claim 1, wherein the options for at least one type of sensitive data are determined based on a training data set.

5. The method of claim 4, wherein the options for the at least one type of sensitive data are determined by iterating the method of claim 1 using the training data set using different options for at least one type of sensitive data during each iteration until an error is less than a prescribed threshold.

6. The method of claim 1, further comprising enriching the prompt with additional information that is not present in the original query and is not sensitive data.

7. The method of claim 6, wherein the additional information is at least one of context and know-how.

8. The method of claim 6, wherein the additional information enables the generative AI to better understand a meaning of at least one other piece of information in the prompt.

9. The method of claim 1, wherein the original query is one of a set of queries that are being evaluated automatically.

10. A non-transitory computer readable medium having stored thereon instructions for causing a processing circuitry to execute a process for evaluating data by a generative artificial intelligence (AI) model to determine for an original query containing sensitive data a result and a reason for that result without leaking substantially any of the sensitive data, the process comprising:
separating non-sensitive data of the original query and at least one type of the sensitive data;
reducing each respective one of the at least one type of sensitive data to one enumerated output selected from a prescribed number of options for that respective type of sensitive data;
expanding each enumerated output to a respective expanded form that is usable by the generative AI model;
combining the expanded forms with the non-sensitive data to form a prompt; and
submitting the prompt to the generative AI model.

11. A system for evaluating data by a generative artificial intelligence (AI) model to determine for an original query containing sensitive data a result and a reason for that result without leaking substantially any of the sensitive data, comprising:
a processing circuitry; and
a memory, the memory containing instructions that, when executed by the processing circuitry, configure the system to:
separate non-sensitive data of the original query and at least one type of the sensitive data;
reduce each respective one of the at least one type of sensitive data to one enumerated output selected from a prescribed number of options for that respective type of sensitive data;
expand each enumerated output to a respective expanded form that is usable by the generative AI model;
combine the expanded forms with the non-sensitive data to form a prompt; and
submit the prompt to the generative AI model.

12. The system of claim 11, wherein the form usable by the generative AI model is a textual language form.

13. The system of claim 11, wherein the system is further configured to:
receive an evaluation of the prompt from the generative AI model; and
take an action based on the received evaluation.

14. The system of claim 11, wherein the options for at least one type of sensitive data are determined based on a training data set.

15. The system of claim 14, wherein the options for the at least one type of sensitive data are determined by configuring the system to iteratively separate, reduce, expand, combine, and submit using the training data set using different options for at least one type of sensitive data during each iteration until an error is less than a prescribed threshold.

16. The system of claim 11, wherein the system is further configured to enrich the prompt with additional information that is not present in the original query and is not sensitive data.

17. The system of claim 16, wherein the additional information is at least one of context and know-how.

18. The system of claim 16, wherein the additional information enables the generative AI to better understand a meaning of at least one other piece of information in the prompt.

19. The system of claim 11, wherein the original query is one of a set of queries that are being evaluated automatically.
